(19) United States
(12) Patent Application Publication
(10) Pub. No.: US 2017/0331524 A1
(43) Pub. Date: Nov. 16, 2017

(54) SYSTEM, DEVICE, AND METHOD FOR ELECTRONIC DEVICE ACTIVATION

(71) Applicant: MC10, Inc., Lexington, MA (US)

(72) Inventors: Alexander J. Aranyosi, Medford, MA (US); Stephen Lee, Ann Arbor, MI (US); Jared Lowe, San Ramon, CA (US)

(21) Appl. No.: 15/526,375

(22) PCT Filed: Nov. 11, 2015
(86) PCT No.: PCT/US15/60184

§ 371 Date: May 12, 2017

Related U.S. Application Data
(60) Provisional application No. 62/081,192, filed on Nov. 18, 2014.

(51) Int. Cl. H04B 5/00

(52) U.S. Cl. CPC H04B 5/0075; H04B 5/0031; H04B 5/0037

(57) ABSTRACT

An apparatus includes an electrical power source and a solid-state circuit located within a housing. The circuit is coupled to the electrical power source such that circuit is initially in an inactive state in which electrical current is prevented from flowing through the solid-state circuit, the inactive state corresponding to an OFF mode of the apparatus. The circuit further includes an active state in which electrical current is allowed to flow through the solid-state circuit, thereby turning the apparatus in an ON mode, the active state being triggered by a momentary voltage and remaining active after the momentary voltage is removed.

### FIELD OF THE INVENTION

The present invention relates to activation of a circuit by placement in close proximity with an activation device such as, for example, a near-field communication (NFC)-enabled device.

### BACKGROUND OF THE INVENTION

As electronic devices, such as, for example, point-of-care medical devices, become smaller and thinner, physical switches for powering the electronic devices often become impracticable and/or otherwise undesirable. Although some solutions have been presented, none of the current solutions works sufficiently well.

For example, one solution is to have the electronic device always on standby. A problem associated with this solution is that storage lifetime is limited and, accordingly, the electronic device may not work when needed.

Another solution has been to include a larger and/or rechargeable battery. The problems associated with this solution are that cost, size, and complexity of the electronic device are increased. Accordingly, existing medical devices can be bulky, due to the size of the power source needed to power operation of the bulkier device. This can limit the applicability of such bulkier devices. The size of the battery (or other energy supply component) can not only add bulk to many existing devices, but can also restrict the possible arrangements of the components of the devices such as, for example, medical devices. As a result of the cost of the large power supplies, existing devices such as, for example, medical devices are likely to be more expensive to produce. It can be difficult to reduce the dimensions and/or cost of such medical devices. Furthermore, such devices even with larger batteries still have a limited shelf life until their batteries are drained.

Yet another solution has been to include a physical switch, such as a power button. However, the physical switch can impair the form factor of the electronic device and may be difficult to operate.

Therefore, there is a continuing need for developing an electronic device that solves the above and other problems.

### SUMMARY OF THE INVENTION

According to some embodiments, an apparatus includes an electrical power source and a solid-state circuit located within a housing. The circuit is coupled to the electrical power source such that circuit is initially in an inactive state in which electrical current is prevented from flowing through the solid-state circuit, the inactive state corresponding to an OFF mode of the apparatus. The circuit further includes an active state in which electrical current is allowed to flow through the solid-state circuit, thereby turning the apparatus in an ON mode, the active state being triggered by a momentary voltage and remaining active after the momentary voltage is removed.

According to some embodiments, an electronic device such as, for example, an electronic point-of-care device lacks a physical power switch (e.g., in the form of a power button) and, instead, has an electrical power switch in the form of an electrical circuit. The point-of-care device is initially inactive in an OFF state in which electrical power from a battery fails to flow completely through the electrical circuit. Based on Near Field Communication (NFC) technology, a handheld device is placed near the point-of-care device to generate a momentary voltage that activates the electrical circuit. At the same time, the handheld device reads the point-of-care device's unique identifier (ID).

In accordance with some embodiments of the present concepts, an electronic apparatus such as, for example, an apparatus for medical care includes an electrical power source and a solid-state circuit located within a housing. The circuit is coupled to the electrical power source such that circuit is initially in an inactive state in which electrical current is prevented from flowing through the solid-state circuit, the inactive state corresponding to an OFF mode of the apparatus. The circuit further includes an active state in which electrical current is allowed to flow through the solid-state circuit, thereby turning the apparatus in an ON mode, the active state being triggered by a momentary voltage and remaining active after the momentary voltage is removed.

In another aspect of the present concepts, a method is directed to activating a an electronic device such as, for example, an electronic medical device and initially in an inactive state. In response to receiving a momentary voltage, a power source of the device is activated to place the device in an active state, the power source remaining active independent of the removal of the momentary voltage. In response to activating the power source, an activation confirmation signal and/or a unique identifier (ID) data signal is automatically outputted by the device.

In yet another aspect of the present concepts, a medical care system includes a point-of-care medical device having a battery and a circuit enclosed within a housing, the medical device being initially in an inactive OFF state in which power from the battery is prevented from flowing through the circuit. The system further includes a Near Field Communications (NFC) device outputting a communication signal in close proximity with the medical device, the communication initiating an active ON state of the medical device that is independent of the NFC activation device and in which power from the battery is allowed to flow through the circuit.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

The invention will be better understood from the following description of exemplary embodiments together with reference to the accompanying drawings, in which:

FIG. 1 is a perspective view illustrating an electronic device;

FIG. 2 is a block diagram of circuitry on an electronic device;

FIG. 3A is a diagram illustrating one embodiment of a solid-state switch circuit of the device of FIG. 1;

FIG. 3B is a diagram illustrating another embodiment of the solid-state switch circuit of the device of FIG. 1;

FIG. 4 is a block diagram of a NFC power-harvesting circuit;

FIG. 5 is a block diagram of exemplary components on an activation device such as an NFC activation device;

FIGS. 6A-6D are perspective views illustrating a process of activation of an electronic device;

FIGS. 7A-7E are perspective views illustrating a process of selective activation of an electronic device when the electronic device and an activation device are brought into close proximity to each other and data exchanged between the activation device and power-harvesting circuitry of the electronic device satisfy predetermined criteria;

FIG. 8 is a perspective view illustrating measurement by a medical device of a patient condition;

FIG. 9 is a flowchart illustrating activating and operation of an electronic device;

FIG. 10 is a flowchart illustrating another example of a process of activating an electronic device;

FIGS. 11A and 11B depict other examples of power-harvesting and switch circuits employing a reed switch;

FIG. 12 depicts a solar cell power-harvesting circuit;

FIG. 13 is a block diagram of circuits on an electronic device according to some embodiments; and

FIGS. 14A and 14B depict other examples of power-harvesting and switch circuits employing an optoelectronic circuit.

### DETAILED DESCRIPTION OF THE ILLUSTRATED EMBODIMENTS

Although the invention will be described in connection with certain exemplary embodiments, it will be understood that the invention is not limited to those particular embodiments. On the contrary, the invention is intended to cover all alternatives, modifications, and equivalent arrangements as may be included within the spirit and scope of the invention as defined by the appended claims.

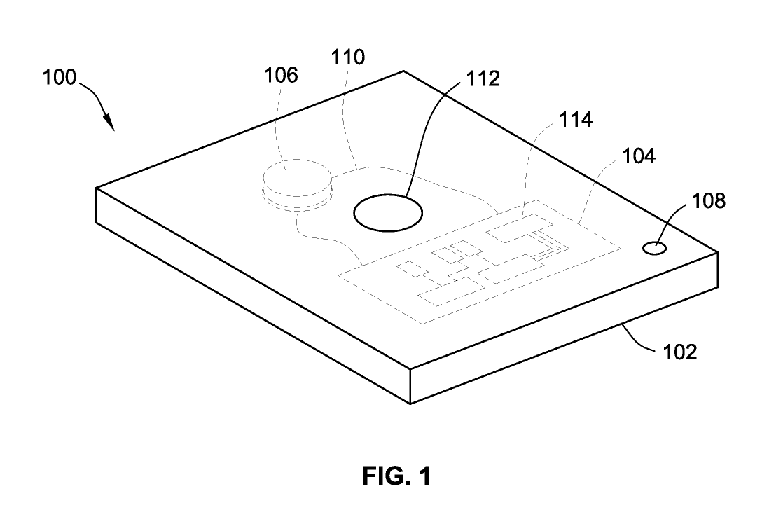

Turning now to the drawings and referring first to FIG. 1, an electronic device 100 includes a housing 102, a circuit 104, a power source such as a battery 106, and an optional power indicator 108. According to some embodiments, the device 100 is a point-of-care medical device. According to some embodiments, the circuit 104 is a solid state circuit. According to some embodiments, the circuit 104 and the battery 106 are enclosed within the housing 102. According to some embodiments, the circuit 104 and/or the battery 106 may be partially enclosed within or mounted or coupled to the housing 102. The battery 106 is electrically coupled via electrical connections 110 with the circuit 104. The device 100 lacks a physical power switch or button. According to some embodiments, the power of device 100 is turned ON automatically in response the device 100 being in close proximity with an activation device such as, for example, a Near Field Communications (NFC) device, as discussed in more detail below. The device 100 includes low leakage components to minimize power loss from the battery 106 when the device 100 is OFF. The circuit 104 optionally includes processor-executable instructions (including firmware) that facilitate the operation of the device 100, such as, for example, analyzing measurements of a sample or a condition of a patient when the device 100 is a point-of-care medical device. According to some embodiments, the device 100 includes one or more test sensors 112. According to some embodiments, the device comprises a memory 114 having a device ID stored therein.

According to some embodiments, the device 100 is a point-of-care medical device used in the field of healthcare, and particularly, in human diagnostics in which tests are performed outside of a central laboratory. Point-of-care devices have improved patient-care efficiency because they allow diagnostic testing to be performed wherever a patient may be located, including performing the testing by the patients themselves. According to some embodiments, point-of-care medical devices not only provide the patients with convenience of self-health monitoring, but also allow remote medical record keeping and diagnoses, for example, by uploading point-of-care test results to a health professionals site through the Internet.

One problem with electronic devices such as, for example, point-of-care medical devices, is that the on-board power source has a limited lifetime giving such devices a limited operating life. Furthermore, in an effort to make electronic devices smaller and cheaper, the capacity of the power source such as a battery may be reduced, further reducing the operating life of such devices. For example, according to some embodiments, the electronic device 100 may have a battery 106 which may have an operating life of only 15 minutes to an hour. If such devices were always ON or in a standby mode, the shelf life of such devices may be very limited. For example, if such devices were made in the United States and had to be shipped to Africa such as by cargo ship, such devices may be dead or non-operational by the time they arrived in Africa because the power source had become drained by being ON or in standby mode. As another example, where the device 100 is a point-of-care medical device, it may be desirable to keep an ample supply of such devices on hand at a health care facility such as, for example, a hospital. However, such devices which are held in storage at a health care facility may become dead or non-operational by the time they are retrieved for use by a patient if such devices are kept in storage in an ON or standby mode.

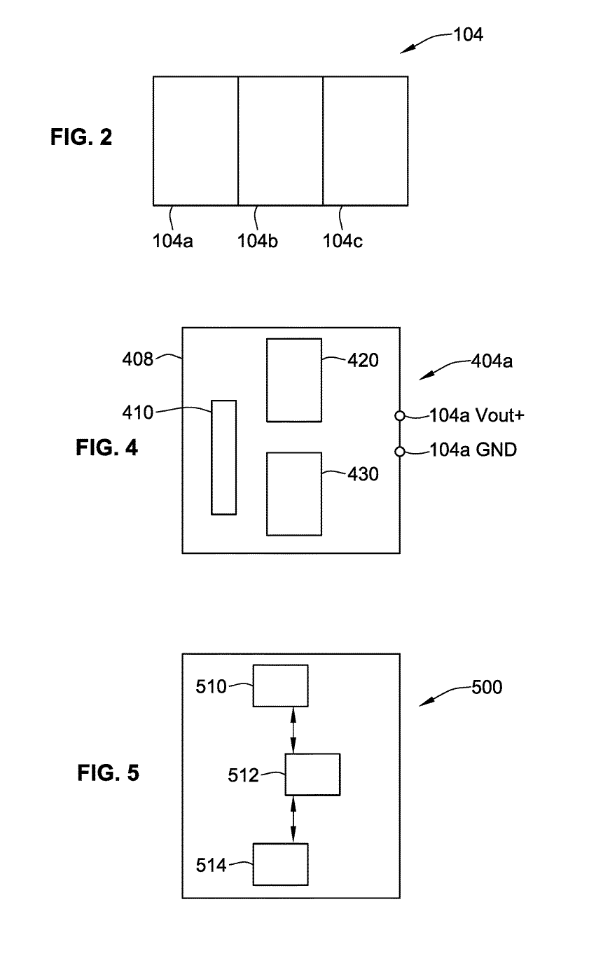

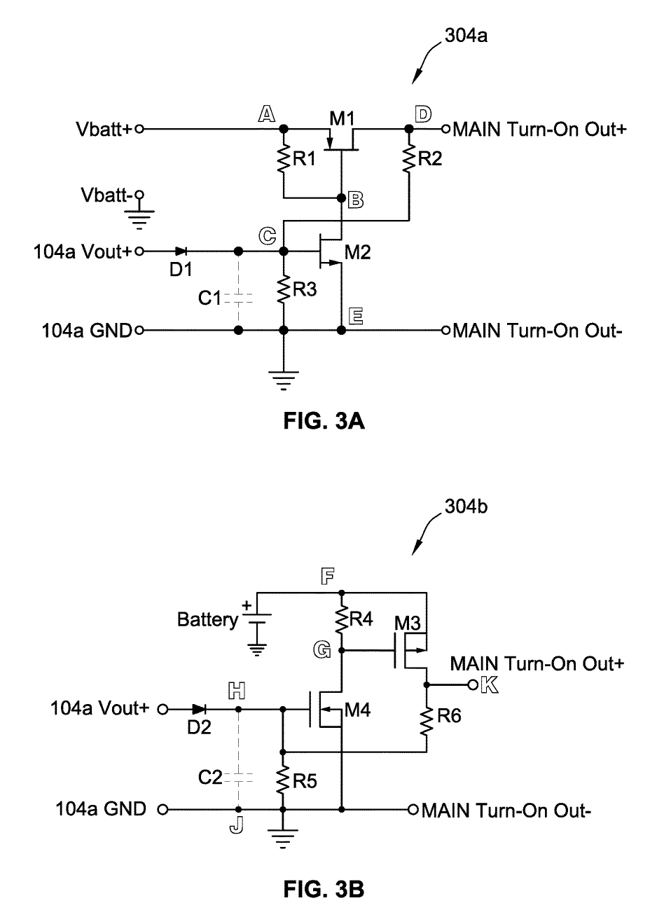

FIG. 2 is a block diagram of circuit 104 on the device 100. The circuit 104 comprises at least three sections of circuitry. Section 104a is an external power-harvesting circuit. Section 104b comprises switch circuitry. Section 104c comprises other circuitry on the device 100, such as, for example, a memory, a microprocessor, and/or test sensor(s), etc. which may be considered the main operational circuitry of the device 100. As will be described in more detail in conjunction with FIGS. 3A and 3B, the switch circuitry 104b controls the turning on of the device 100 by allowing or preventing the power source 106 from powering the other or main circuitry 104c. According to some embodiments, some or all of the circuitry 104a, 104b, and/or 104c is solid-state circuitry.

FIG. 3A illustrates one embodiment of the switch circuitry 104b, namely, a solid-state switch circuit 304a of the electronic device 100. The switch circuit 304a comprises a passive first transistor M1 that closes the circuit between the battery 106 and the device 100. The source, or first terminal, of the passive first transistor M1 is coupled to node A as is one of end of a first resistor R1. One terminal, Vbatt+, of the battery or power source 106 is also coupled to node A. The other terminal, Vbatt−, of the battery or power source 106 is coupled to ground. The gate of M1 and the other end of R1 is coupled to node B. The drain, or second terminal, of M1 is couple to node D which corresponds to Main Turn-On Out+ of the other or main circuit 104c.

The switch circuit 304a further comprises a second transistor M2, a second resistor R2, a third resistor R3, and an optional diode D1. The diode D1 is coupled between 104a Vout+ of the power-harvesting circuit 104a and node C of the switch circuit 304a. The second resistor R2 is coupled between node C and drain of transistor M1 at node D. The gate of the second transistor M2 is coupled to node C while the drain of the second transistor M2 is coupled to the gate of the first transistor M1 at node B. The source of the second transistor M2 is coupled to node E which is coupled to the 104a GND of the power-harvesting circuit 104a and the Main Turn-ON Out- of the other or main circuit 104c and ground. The third resistor R3 is coupled between nodes C and E.

The first resistor R1 keeps the voltage (VGS) across nodes A and B below the threshold voltage Vth of the first transistor M1, keeping the first transistor M1 open.

When an activation device or signal is brought into close proximity with the device 100, the activation device's signal induces a signal in the power-harvesting circuit 104a of the device 100 that causes the circuit 104a to output a voltage (or current) at 104a Vout+ such as a momentary voltage (or current). The 104a Vout+ is sufficient to pull the gate of the second transistor M2 at node C high, turning the drain of the second transistor M2 at node B low. In turn, the gate of the first transistor M1 at node B is pulled low, closing the first transistor M1 such that the voltage and current on Vbatt+ is passed to Main Turn-On Out+ (connecting the battery at node A to the other or main circuit 104c of the device 100).

The third resistor R3 keeps the gate of the second transistor M2 at node C low before the battery voltage has passed through the first transistor M1. When transistor M1 is closed, the second resistor R2 helps serve to latch the second transistor M2 ON. According to one example, the first resistor R1 has a resistance of 1 Mohm, the second resistor R2 has a resistance of 1 Mohms, and the third resistor R3 has a resistance of 10 Mohms.

According to some embodiments, the switch circuit 304a optionally includes a capacitor C1 coupled between node C and node E.

FIG. 3B illustrates another embodiment of the switch circuitry 104b, namely, a solid-state switch circuit 304b of the device 100. The solid-state circuit 304b illustrates another embodiment in which the battery 106 is initially electrically decoupled from the other or main circuit 104c such that electrical power is prevented from turning ON the other or main circuit 104c of the device 100. The switch circuit 304b comprises a passive first transistor M3, a second transistor M4, a first resistor R4, a second resistor R5, a third resistor R6, an optional diode D2, and optionally a capacitor C2.

One terminal of the battery 106 is coupled to ground and the other terminal is coupled to node F. The first transistor M3 has a gate coupled to node G, a source coupled node F, and a drain coupled to node K. The first resistor R4 is coupled between nodes F and G.

The optional diode D2 is coupled between 104a Vout+ of the power-harvesting circuit 104a and node H of the switch circuit 304b. The second resistor R5 is coupled between node H and node J which is coupled to the 104a GND of the power-harvesting circuit 104a and the Main Turn-ON Out-of the other or main circuit 104c. Likewise, according to some embodiments, the capacitor C2 is coupled between nodes H and J.

The gate of the second transistor M4 is also coupled to node H. The drain of the second transistor M4 is coupled to node G and the gate of the first transistor M3. The source of the second transistor M4 is coupled to node J which is coupled to ground. The third resistor R6 is coupled between nodes H and K.

When an activation device is brought into close proximity with the device 100, the activation device's signal induces a signal in the power-harvesting circuit 104a of the device 100 that causes the power-harvesting circuit 104a to output a voltage at 104a Vout+ such as a momentary voltage. The 104a Vout+ is sufficient to pull the gate of the second transistor M4 at node H high, turning the drain of the second transistor M4 at node G low. In turn, the gate of the first transistor M3 at node G is pulled low, closing the first transistor M3 such that the voltage and current on Vbatt+ is passed to Main Turn-On Out+ (connecting the battery at node F to the other or main circuit 104c of the device 100 at node K).

The switch 304b optionally includes the capacitor C2 to provide a low impedance path from 104a Vout+ to 104a GND. However, similar to switch circuit 304a, an activation signal causes the solid-state main circuit 104c to turn ON. The third resistor R6 keeps the gate of the second transistor M4 at node H high after the battery voltage has passed through the first transistor M3. Thus, the third resistor R6 helps serve to latch the second transistor M4 ON. According to some embodiments, resistors R4, R5, and R6 of switch circuit 304b correspond to and have the same values as resistors R1, R3, and R2, respectively, of switch circuit 304a.

Turning to FIG. 4, according to some embodiments, the power-harvesting circuit 104a is a NFC power-harvesting circuit 404a such as an NFC chip 408 comprising circuitry such as an antenna 410 to generate a turn-on signal in response to being located near an NFC activation device. According to some embodiments, the NFC circuit contains an antenna 410 and NFC transceiver IC 420. Additionally, according to some embodiments, the NFC circuitry or chip has its own non-volatile memory 430. According to some embodiments, the memory 430 comprises one or more registers and/or other non-volatile memory.

With respect to FIG. 3A, when an NFC activation device is brought into close proximity with the device 100 comprising a NFC power-harvesting circuit such circuit 404a, the NFC activation device's signal induces a signal in the NFC power-harvesting circuit 404a of the device 100 that causes the NFC integrated circuit (IC) 420 to output a voltage at 104a Vout+ such as a momentary voltage. The 104a Vout+ is sufficient to pull the gate of the second transistor M2 at node C high, turning the drain of the second transistor M2 at node B low. In turn, the gate of the first transistor M1 at node B is pulled low, closing the first transistor M1 such that the voltage and current on Vbatt+ is passed to Main Turn-On Out+ (connecting the battery at node A to the other circuit 104c of the device 100).

With respect to FIG. 3B, when an NFC activation device is brought into close proximity with the device 100 comprising a NFC power-harvesting circuit such circuit 404a, the NFC activation device's signal induces a signal in the NFC power-harvesting circuit 404a of the device 100 that causes the NFC integrated circuit (IC) 420 to output a voltage at 104a Vout+ such as a momentary voltage. The 104a Vout+ is sufficient to pull the gate of the second transistor M4 at node H high, turning the drain of the second transistor M4 at node G low. In turn, the gate of the first transistor M3 at node G is pulled low, closing the first transistor M3 such that the voltage and current on Vbatt+ is passed to Main Turn-On Out+ (connecting the battery at node F to the other circuit 104c of the device 100 at node K).

In alternate embodiments, power-harvesting circuit 104a comprises one or more of the following in place of or addition to an NFC power-harvesting circuit 404a: an electromagnetic radiation detection circuit such as a magnetic detection circuit, a light detection circuit such as a photo detector, a thermal detector which may be activated by heat and/or cold.

For example, according to some embodiments, circuits 104a and 104b comprises a reed switch which is normally in an open state but is moved to a closed state in response to a magnet being brought into proximity to the apparatus 100. When the reed switch is closed, power from the battery 106 flows through main circuit 104c and the power from the battery 106 maintains the apparatus in the ON or active state. For example, when used in connection with the switch circuits 304a, 304b illustrated in FIGS. 3A and 3B, the switch circuits 304a, 304b serve as a latch. Once a signal is high at the gate of M2 (node C) or gate of M4 (Node H), the switch circuit 304a, 304b activates, closes the connection between the battery and the remainder of the measurement or main circuit 104c and also latches in an ON state. Accordingly, when the signal is removed at node C or H (such as when the magnet is no longer in proximity to device 100), the connection is still maintained. According to some embodiments, the maintenance of the switch 304a, 304b in the latched or ON state is accomplished by using the battery 106 to keep the gate at Node C or Node H high.

FIG. 5 is a block diagram of exemplary components on a NFC activation device 500. According to some embodiments, the NFC activation device 500 include an NFC circuit 510 communicatively coupled to a processor 512, and a memory 514 communicatively coupled to the processor 512. The NFC circuit 510 comprises an antenna. The NFC circuit 510 may generate a signal, such as an RF signal, that induces a signal in the NFC circuit 104a of the device 100. As understand by one skilled in the art, the NFC circuit 510 may be used to wirelessly transmit data to and wirelessly receive data from another NFC activation device such as the device 100.

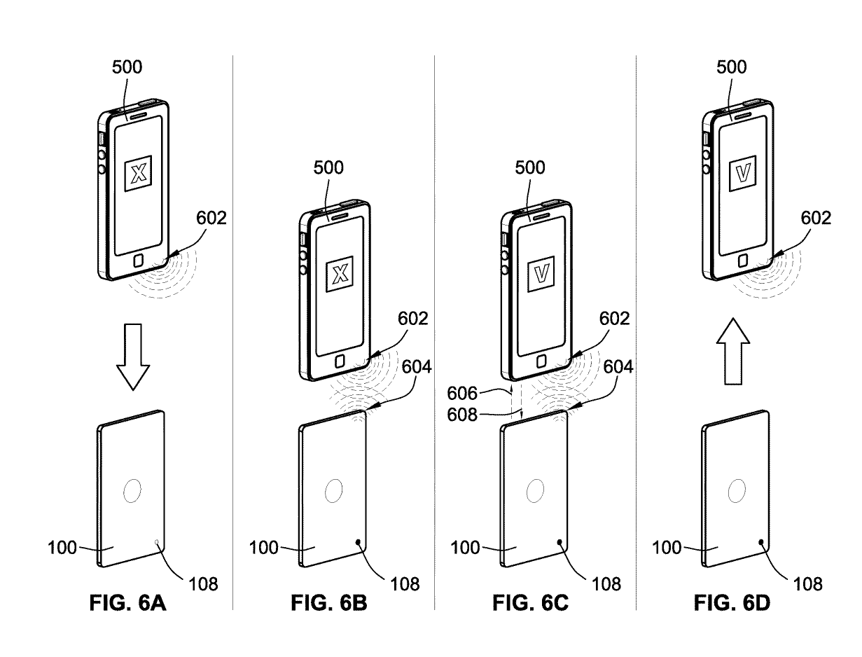

Referring to FIGS. 6A-6D, activation of the device 100 is achieved when the device 100 and an NFC activation device 500 are brought into close proximity to each other. For example, in FIG. 6A, the device 100 and the NFC activation device 500 are moved in close proximity with each other such as by moving the NFC activation device 500 near the device 100 or vice versa or where both devices 100 and 500 are moved. In the illustrated embodiment the NFC activation device 500 is in the form of a smartphone or a mobile telephone but as will be described below other forms for NFC activation devices are also contemplated.

According to some embodiments, the device 100 is optionally initially removed from a sterile package prior to becoming in close proximity with the NFC activation device 500. According to some embodiments, the distance between the device 100 and the NFC activation device 500 can range from zero, in which the device 100 and the NFC activation device 500 are in contact with each other, to a maximum distance of approximately 20 centimeters (or about 8 inches). By way of one example, one practical working distance is approximately 4 centimeters (or about 1.5 inches) or less.

The NFC activation device 500 outputs an NFC communication 602, such as a radio communication, powers up power-harvesting circuit 404a that in turn helps complete the electrical connection between the battery 106 and the solid-state circuit 104c. Thus according to some embodiments, bringing the NFC activation device 500 in close proximity with the device 100 activates the device 100 by radio-frequency (RF) transmission/inductive coupling. For example, according to some embodiments, the NFC communication 602 induces a momentary voltage (such as at node C of switch circuit 304a or node H of switch circuit 304b that activates the switch circuitry 104b and activates or turns ON the device 100 by enabling power from the power source 106 to flow to the main or rest of the circuitry 104c.

As illustrated in FIG. 6B, the device 100 has now been switched ON and outputs its own NFC communication 604 such as via the NFC power-harvesting circuit 404a of the device 100. According to some embodiments, the active ON state of the device 100 is optionally visually indicated by the power indicator 108 (e.g., via a light that turns ON).

As illustrated in FIG. 6C, the device 100 and the NFC activation device 500 may exchange one or more data signals 606, 608 with each other. For example, according to some embodiments, the device 100 transmits a unique identifier (ID) and/or other data such as, for example, stored in memory 430 to the NFC activation device 500. Upon receipt of the unique identifier (ID) and/or other data, the NFC activation device 500 verifies and/or confirms the received ID and/or other data is acceptable or satisfactory such as described elsewhere in the present disclosure. According to some embodiments, the NFC activation device 500 links the received ID of the device 100 with a patient record stored in memory 514 of the NFC activation device 500. In addition to or instead of the ID, the device 100 and the NFC activation device 500 such as a mobile telephone may exchange other identifying information. The patient record, such as a health record, is optionally stored in the memory 514 of the NFC activation device 500. According to some embodiments, the device 100 is associated with a patient or individual and the NFC activation device 500 is a device used by the patient's clinician such as the patient's clinician's smartphone.

One benefit of linking the ID of the device 100 with the patient record is that it ensures that results of measurements and associated collected data are associated with the correct patient. Thus, data integrity is ensured based on the ID-patient record link.

Optionally, the device 100 and the NFC activation device 500 also transfer data related to calibration of the device 100 and/or measurements performed by the device 100. The measurements can include obtaining biological diagnostics for a human immunodeficiency virus (HIV) condition, a malaria condition, a nutrition condition, a neurological disorder condition, a cardiac infraction condition, and/or a hydration condition.

As illustrated in FIG. 6D, the device 100 is no longer in close proximity with the mobile telephone 500. Nevertheless, the device 100 continues to remain in the ON state independent of relative location or proximity of the NFC 500.

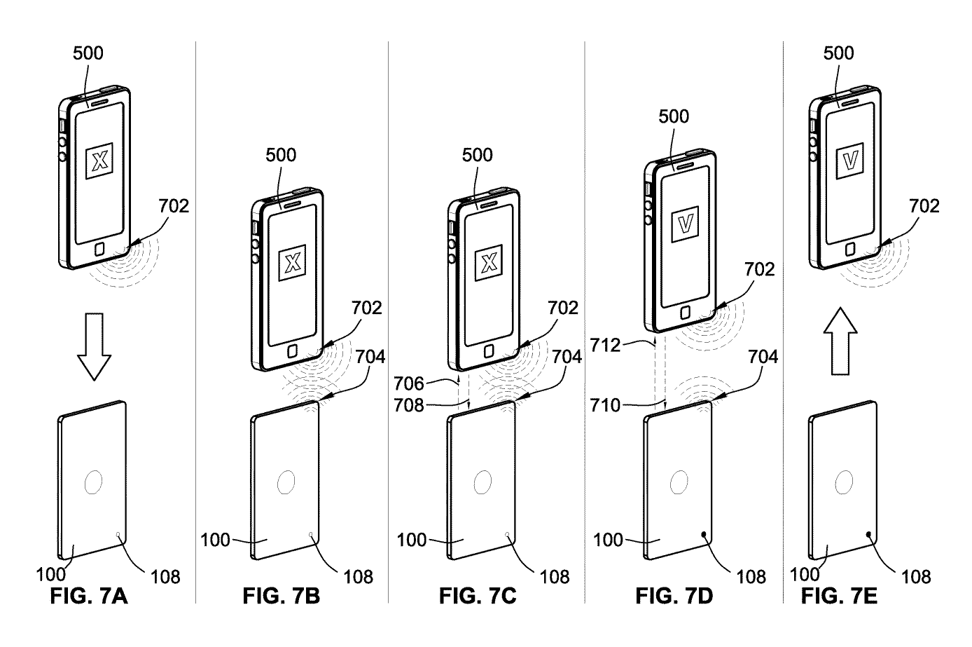

According to some embodiments, proximity alone establishes communication between the activation device 500 and NFC power-harvesting circuit 404a, but that does not necessarily activate switch circuitry 104b or turn ON the device 100. Additional communication may be required to activate switch circuitry 104b. For example, referring to FIGS. 7A-7D, activation of the device 100 is selectively achieved when the device 100 and an NFC activation device 500 are brought into close proximity to each other and data exchanged between the NFC activation device 500 and the power-harvesting circuitry 404a satisfy predetermined criteria.

In FIG. 7A, the device 100 and the NFC activation device 500 are moved in close proximity with each other such as by moving the NFC activation device 500 near the device 100 or vice versa or where both devices 100 and 500 are moved. In the illustrated embodiment the NFC activation device 500 is in the form of a smartphone or a mobile telephone but as will be described below other forms for NFC activation devices are also contemplated.

According to some embodiments, the device 100 is optionally initially removed from a sterile package prior to becoming in close proximity with the NFC activation device 500. According to some embodiments, the distance between the device 100 and the NFC activation device 500 can range from zero, in which the device 100 and the NFC activation device 500 are in contact with each other, to a maximum distance of approximately 20 centimeters (or about 8 inches). By way of one example, one practical working distance is approximately 4 centimeters (or about 1.5 inches) or less.

The NFC activation device 500 outputs an NFC communication 702, such as a radio communication, powers up power-harvesting circuit 404a such as the NFC chip 408. Thus according to some embodiments, bringing the NFC activation device 500 in close proximity with the device 100 activates the power-harvesting circuit 404a by radio-frequency (RF) transmission/inductive coupling.

As illustrated in FIG. 7B, the NFC power-harvesting circuit 404a of the device 100 outputs its own NFC communication 704 such as via the NFC power-harvesting circuit 404a of the device 100 via antenna 410.

As illustrated in FIG. 7C, the NFC power-harvesting circuit 404a of the device 100 and the NFC activation device 500 may exchange one or more data signals 706, 708 with each other. For example, according to some embodiments, the NFC power-harvesting circuit 404a transmits a unique identifier (ID) and/or other data such as, for example, stored in memory 430 to the NFC activation device 500. Upon receipt of the unique identifier (ID), the NFC activation device 500 verifies and/or confirms the received ID and/or other data is acceptable or satisfactory such as described elsewhere in the present disclosure (e.g., the device 100 has the ID the activation device 500 is looking for and/or is the type of device desired by the activation device such as being a malnutrition testing device as opposed to a breast cancer testing device or vice versa).

The exchange of data described above in connection with FIG. 7C can all take place prior to activating switch circuitry 104b or powering ON the main circuitry 104c of the device 100. Consequently, the results of this communication can be used by device 500 to determine whether to activate or turn ON the device 100 by enabling power from the power source 106 to flow to the main or rest of the circuitry 104c.

According to such embodiments, data signals 706 and 708 comprise a request for data from device 500 and a response from NFC power-harvesting circuit 404a, where this response can include the unique identifier (ID) in addition to other data. Accordingly, device 500 and power-harvesting circuit 104a can exchange signals 706 and 708 BEFORE device 100 is powered on. This exchange can communicate a unique ID for device 100, other information to specify the type of device 100, etc. from the device 100 (power-harvesting circuit 104a) to the activation device 500. Device 500 then processes this received data.

Turning to FIG. 7D, if device 500 chooses to activate device 100, the NFC activation device 500 transmits a turn-on data signal 710 that represents an activation signal from device 500. At this point power-harvesting circuit 404a activates the switch circuit 104b, which turns ON the main or rest of the circuitry 104c. An LED 108 to indicate this activation state is optional.

For example, according to some embodiments, the NFC activation circuit 404a induces a momentary voltage (such as at node C of switch circuit 304a or node H of switch circuit 304b that activates the switch circuitry 104b and activates or turns ON the device 100 by enabling power from the power source 106 to flow to the main or rest of the circuitry 104c. As illustrated in FIG. 7D the device 100 has now been switched ON and outputs its own NFC communication 704 such as via the NFC power-harvesting circuit 404a of the device 100. According to some embodiments, the active ON state of the device 100 is optionally visually indicated by the power indicator 108 (e.g., via a light that turns ON)

The device 100 can then optionally send an acknowledgment signal 712 to activation device 500 confirming that the device 100 has in fact been turned on.

Thus, according to some embodiments, with NFC activation, communication is established between the activation device 500 (e.g. a mobile phone) and the NFC chip 408. The NFC chip 408 has its own non-volatile memory such as memory 430. The NFC chip 408 receives power from the activation device 500, but does not transmit a signal 706 that turns on the rest of the circuit 104c until instructed to do so. Before this happens, the activation device 500 can query the NFC chip 408, e.g. to read data stored in the chip's memory 430. This data can include, among other things, information about the type of circuit 104c or device 100 that is connected to the NFC chip 408—for example, whether it's a heart rate monitor, blood glucose meter, etc. Based on this and other information, the activation device 500 can determine whether the device 100 to which it is currently communicating with is the type of device it expects or desires to turn ON before sending a turn-on signal and activating the switch circuit 104b of the device 100. For example, if the activation device 500 currently desires to receive, for example, heart rate information (such as to, for example, record a heart rate), the activation device 500, would not to transmit an activation or turn-on signal 710 if the NFC chip 408 sent data 708 indicating the device 100 was a blood glucose meter device. The NFC activation device 500 can also examine other information, such as recording the unique ID encoded into each NFC chip and comparing it to about database of such IDs to determine whether the device had previously been used. For example, if the activation device 500 desired to read heart-rate information from a device 100, and the currently communicatively coupled device 100 sent data that is was a heart-rate monitoring device but one that had not yet been previously activated or turned-on, the activation device 500 would not to transmit an activation or turn-on signal 710 as the activation device 500 would know that the current device 100 has no such data stored thereon. One advantage of such controlled or selective sending of a turn-on signal 710 is that devices 100 are not turned on inadvertently and undesirably caused to use up their power sources 106. Thus, for example, an NFC activation device 500 can be controlled to not inadvertently turn-on multiple devices 100 simply by passing in close proximity to a plurality of devices 100.

According to some embodiments, the NFC activation device 500 links the received ID of the device 100 with a patient record stored in memory 514 of the NFC activation device 500. In addition to or instead of the ID, the device 100 and the NFC activation device 500 such as a mobile telephone may exchange other identifying information. The patient record, such as a health record, is optionally stored in the memory 514 of the NFC activation device 500. According to some embodiments, the device 100 is associated with a patient or individual and the NFC activation device 500 is a device used by the patient's clinician such as the patient's clinician's smartphone.

One benefit of linking the ID of the device 100 with the patient record is that it ensures that results of measurements and associated collected data are associated with the correct patient. Thus, data integrity is ensured based on the ID-patient record link.

Optionally, the device 100 and the NFC activation device 500 also transfer data related to calibration of the device 100 and/or measurements performed by the device 100. The measurements can include obtaining biological diagnostics for a human immunodeficiency virus (HIV) condition, a malaria condition, a nutrition condition, a neurological disorder condition, a cardiac infraction condition, and/or a hydration condition.

As illustrated in FIG. 7E, the device 100 is no longer in close proximity with the mobile telephone 500. Nevertheless, the device 100 continues to remain in the ON state independent of relative location or proximity of the NFC 500.

According to some embodiments, in FIGS. 7A-7E (and FIGS. 6A-6D) the “X” on the display of activation device 500 indicates that device 500 believes that device 100 has not been activated yet, while the “V” indicates that device 500 thinks that device 100 has been activated. The display of an appropriate message on the display of device 500 (such as an “X” or “V”) is optional.

According to some embodiments, there are two ways in which device 500 can decide that device 100 has been activated. According to the first way, the device 500 assumes that if it has sent a turn-on data signal 710 or an activation signal, the activation signal was received by device 100 and the device 100 has in fact been activated and is working properly.

According to a second way, after sending the activation signal 710, device 500 explicitly requests an acknowledgment signal from device 100 that device 100 has been activated such as, for example, acknowledgment signal 712. Receipt by device 500 of this acknowledgment is used by device 500 to verify that activation was successful. For example, according to some embodiments, upon activation, device 100 could change the value at a specified memory location in memory 430. Device 500 could read that value before and after sending the activation signal to verify that device 100 has been activated successfully (such as by requesting that device 100 send such value to device 500). A benefit of this approach is that it provides an independent verification that the device 100 was activated. For example, if optional indicator 108 were not present, this verification could serve as the primary way to verify that activation was successful. Note that this second approach is applicable to both FIGS. 6 and 7. According to some embodiments, regardless of whether device 100 is verified by device 500 prior to activation, the activation of device 100 itself can be verified by device 500 afterward.

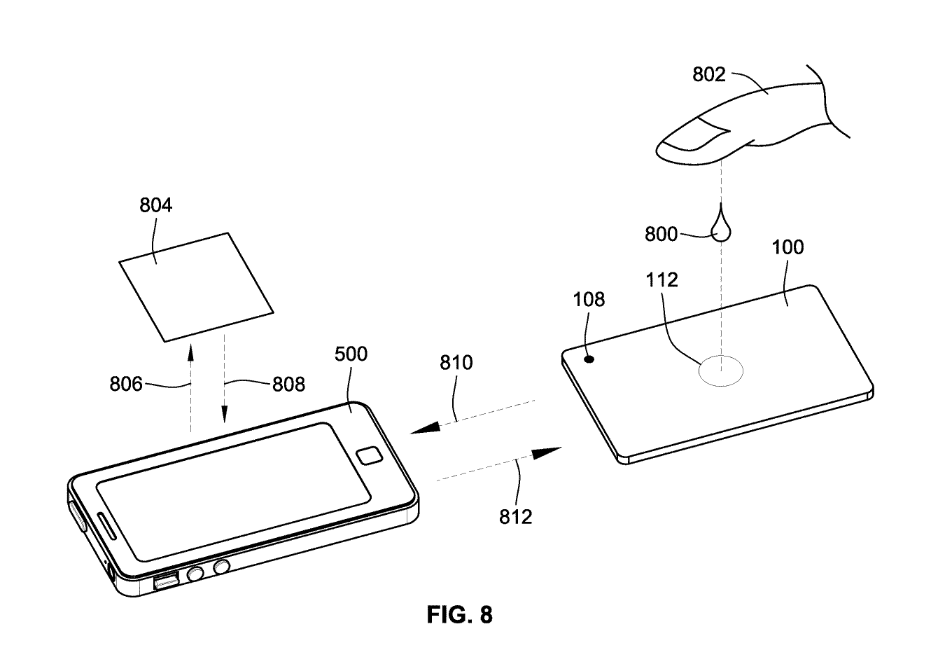

Referring to FIG. 8, the device 100 is illustratively used to measure data for a user, such as a patient. For example, a blood droplet 800 from the user's finger 802 is placed on sensor 112 of the device 100. The device 100 may perform one or more analysis tasks to determine measurements or other data related to the user/patient. When the NFC activation device 500 is placed in close proximity with the device 100, data such as results of the analysis tasks may be wirelessly transmitted to the NFC activation device 500 and recorded or stored in the memory 514 of the NFC activation device 500. The data signals 810, 812 communicated between the device 100 and the NFC activation device 500 such as via NFC communications 602, 604, 702, 704 facilitate any necessary data exchange required to complete the analysis.

Quantitative information from analysis of a sample, such as the blood droplet 800, may be used, for example, to determine glucose levels or to diagnose diseases, e.g., malaria, HIV, etc. for the user of device 100. For example. when a sample, such as (but not limited to) the blood droplet 800 is placed onto a testing platform or sensor(s) 112, a pre-deposited assay can be used to analyze the sample in conjunction with, for example, one or more photosensors to determine, for example, the color of the sample and assay combination. As non-limiting examples, a measurement platform based on the example measurement devices described herein in conjunction with the other circuitry 104c can be configured to provide data or other information indicative of at least one constituent of the sample. In an example, the data or other information can be stored to a memory 114 of the device 100 and/or memory 430 of the NFC power-harvesting circuit 404a or transmitted wirelessly. In another example, the measurement platform/sensor(s) 112 based on the example measurement devices described herein in conjunction with the other circuitry 104c can be configured to provide an indication of the data or other information from the quantitative measurements, such as (but not limited to) a change in a color indication, a symbol, and/or a digital readout.

Optionally, data received by and/or stored in the memory 514 on the NFC activation device 500 is further communicated to an external data storage 804, such as a patient management facility, for storage and/or additional analysis. The external data storage 804 may include, for example, a network, a server, or a cloud database, and/or any other external device having a memory for storage of data. Data signals 806, 808 facilitate the exchange of data between the NFC activation device 500 and the external data storage 804. The data signals 806, 808 may include, for example, cellular, Wi-Fi, RF communication, communication Bluetooth®, NFC, and/or infrared or non-infrared light-emitting-diode (LED) signals.

The data measured or generated by the device 100 may selectively be transmitted to one or more activation devices 500. According to some embodiments the device 100 such as via the main circuitry 104c and/or the power-harvesting circuitry 104a records in memory 114, 430 when data has been collected, generated, stored, and/or read by an activation device 500 and such data may be transmitted to an activation device 500.

According to some embodiments, data retrieved or generated by the main or the rest of the circuitry 104c once the device 100 is powered ON is stored in non-volatile memory 430 in the NFC power-harvesting circuit 404a. According to such embodiments, the other circuitry 104c is communicatively coupled to memory 430 so that such data may be stored in the memory 430. Such embodiments have the advantage of permitting data to be read from memory 430 in the power-harvesting circuit 404a even after the power source 106 has been drained and the main circuitry 104c (optionally including, for example, memory 114) is no longer operational. According to such embodiments, even though the device 100 may no longer be powered and may be incapable of being powered on again (e.g., because battery 106 is dead), data may still be read from memory 430 by bringing the device 100 and an activation device 500 in close proximity with each other. When an activation device 500 is in close proximity to device 100, the NFC power-harvesting circuit 404a is powered on the circuit 404a such as NFC chip 408 can transmit data stored in memory 430 to the activation device 500 such as via signal 604 or 704.

One benefit of the device 100 is that two different actions, which have been performed separately in previous devices, may be combined into a single action that is effortless, faster, and more reliable than previous devices. More specifically, the device 100 may be (a) turned ON and (b) the ID of the device 100 and/or other data may be shared with an activation device simply by bringing an appropriate activation device 500 near an appropriate electronic device and without the depression or selection of any buttons or switches on the electronic device 100. Thus, a typical separate “turn-ON” step in previous devices has been eliminated with the device 100.

Yet another benefit of the device 100 is that the circuit 104 takes advantage of the NFC output power of the NFC activation device 500 such as mobile telephone to close a circuit switch to the battery 106, connecting the rest of circuit 104c to the battery 106 and allowing the device 100 to continue to operate even after the mobile telephone 500 has been removed.

Yet another benefit of the device 100, according to some embodiments, is that it lacks a physical power button. Accordingly, according to some embodiments, the device 100 can be manufactured in a smaller and/or thinner size than otherwise possible if the physical power button was required.

Yet another benefit of the device 100, according to some embodiments, is that it allows for longer battery life or for smaller batteries (if using a primary cell). Because the battery is disconnected from the circuit until activated, battery life is preserved until it is actually needed.

Yet other benefits of the device 100, according to some embodiments, are that it allows for longer term storage and for longer-term inventory of medical devices 100. In turn, these benefits result in less cost associated with storage of the device 100.

Yet another benefit of the device 100, according to some embodiments, is that it enables software verification of turn-ON, which indicates to a user that the device 100 is operating properly. For example, the power indicator 108 provides a visual illustration to a user that the device 100 is ON.

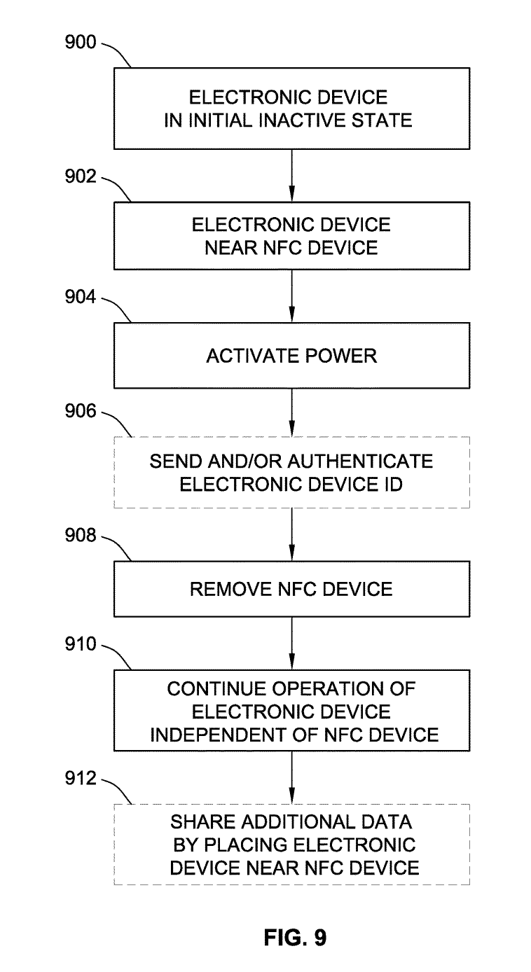

Referring to FIG. 9, a flowchart illustrates another example of a process of activating an electronic device such as device 100 which may be, for example, a medical device. Initially, at 900, an electronic device is in an initial inactive state in which power is not active (i.e., the device 100 is OFF) and power from the power source 106 is not driving the main or other circuitry 104c of the device 100. The device 100 and an NFC activation device such as NFC activation device 500 are brought into relatively proximity to each other, at 902, and, in response, power is activated at 904, e.g., power from the power source 106 drives the main or other circuitry 104c of the device 100. According to some embodiments, in response to the action at step 902 or 904, the ID of the medical device may be automatically transmitted by the device 100 to the NFC activation device and may be authenticated by the NFC activation device at 906. At 908, the NFC activation device and the device 100 may be removed from close proximity to each other such as when the NFC activation device is removed from close proximity with the device 100or vice versa. Then at 910, the device 100 continues to operate autonomously independent of relative proximity or remoteness of the NFC activation device. According to some embodiments, additional data is shared between the two devices at 912 by placing the device and the NFC activation device near each other or where the devices where never separated from each other at step 908.

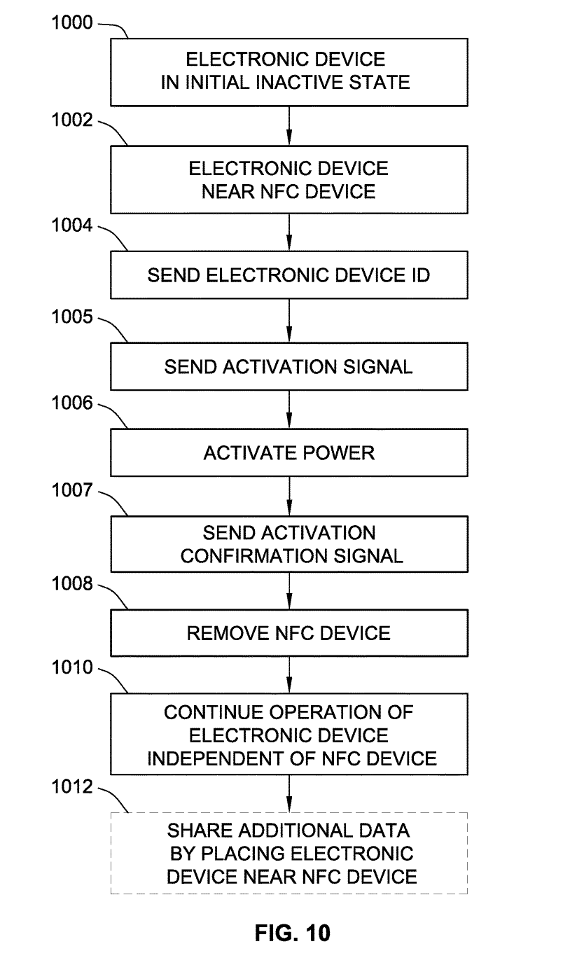

Referring to FIG. 10, a flowchart illustrates another example of a process of activating an electronic device such as device 100 which may be, for example, a medical device. Initially, at 1000, an electronic device is in an initial inactive state in which power is not active (i.e., the device 100 is OFF) and power from the power source 106 is not driving the main or other circuitry 104c of the device 100. The device 100 and an NFC activation device such as NFC activation device 500 are brought into relatively proximity to each other, at 1002.

According to some embodiments, in response to the action at step 1002, the power-harvesting circuit 104a/404a of the electronic device is powered by being in close proximity to the activation device and the ID and/or other data of the electronic device (such as may be stored in memory 430) is automatically transmitted by the electronic device 100 (such as by the NFC chip 408) to the NFC activation device at 1004. According to some embodiments, the ID is a unique ID specifically identifying the particular electronic device 100 and distinguishing it from all other electronic devices 100. According to some embodiments, this ID or identifier is written immutably by the manufacturer of the device 100 or power-harvesting circuit 104a/404a such as the manufacturer of a NFC transceiver IC (or NFC chip 408) and uniquely identifies device 100.

According to some embodiments, activation device such as NFC activation device 500 can optionally have access to data corresponding to a collection of these identifiers that can be used to provide additional information, such as the type of device that device 100 is, when the device was manufactured, whether it has been used previously, etc. Such data may be stored in the memory 514 of the activation device 500 and/or the activation 500 may be communicatively coupled to an external memory (e.g., via wireless communication) having such data stored therein.

According to some embodiments, the NFC activation device compares the received ID and/or other data to reference data stored in memory 514 of the activation device 500. If the ID and/or other data satisfy predetermined or desired criteria, the activation device 500 sends a turn-on or activation signal to the electronic device 100 at 1005. At 1006, the device 100 receives the activation signal, and, in response, power of the device 100 is activated at 1004, e.g., power from the power source 106 drives the main or other circuitry 104c of the device 100. At 1007, the device 100 may optionally send an activation confirmation signal to the activation device 500 to confirm or verify that the device 100 has been powered ON successfully.

At 1008, the NFC activation device and the electronic device 100 may be removed from close proximity to each other such as when the NFC activation device is removed from close proximity with the electronic device 100 or vice versa. Then at 1010, the electronic device 100 continues to operate autonomously independent of relative proximity or remoteness of the NFC activation device. According to some embodiments, additional data is shared between the two devices at 1012 by placing the electronic device 100 and the NFC activation device near each other or where the devices where never separated from each other at step 1008.

According to some embodiments, while the electronic device 100 is powered on (i.e., the main or other circuitry 104c is being powered by power source 106), the device 100 performs one or more tests and/or takes various readings (e.g., temperature, light readings, etc.) and/or otherwise generates data and stores this data in a memory (e.g., memory 430) in or electrically coupled to the power-harvesting circuit 104a (such as 404a) such that the memory may be powered by energy harvested by the power-harvesting circuit 104a. Subsequently, the power source 106 may run out of power (e.g., a battery dies) and the electronic device 100 becomes no longer powered ON. According to some embodiments, while the device 100 is no longer powered ON, an activation device such as NFC activation device 500 is brought into close proximity with the electronic device 100, the power-harvesting circuit 104a/404a harvests power from the activation device and uses the harvested power to power in power-harvesting circuit 104a/404a such as NFC chip 408 including, for example, the processor 420 and memory 430). The power-harvesting circuit 104a/404a then sends some or all of the data stored memory powered by the power-harvesting circuit 104a/404a such as memory 430 to the activation device such as NFC activation device 500. According to some embodiments, prior to sending data collected or generated by the main or other circuitry 104c of the device 100, the device 100 and activation device 500 share authentication data to determine if it is appropriate or desired to send such data from device 100 to a particular activation device 500 (such as by sending a device ID and/or device type data and/or user data (such as patient ID data where the electronic device 100 is a medical testing device). The activation device receives this authentication data and compares it to and/or determines if it satisfies predetermined or desired criteria (e.g., activation device 500 is looking to receive data from an electronic device having a specified ID, and/or having a particular device type such as being a blood glucose measuring medical device and/or being associated with a particular patient such as a patient having a particular patient ID code associated therewith, e.g., Mary J. Smith having patient ID code MJS2200013625). If the authentication data satisfies the desired or predetermined criteria, the activation device 500 then sends a request for the data collected or generated by the main or other circuitry 104c of the device 100 and the power-harvesting chip 104a/404a (e.g., NFC chip 408) then sends the requested data collected or generated by the main or other circuitry 104c of the device 100 to the activation device 500. According to some such embodiments, this last action is accomplished even though the power source 106 of the electronic device is dead and the electronic device 100 is not powered ON.

According to some embodiments, the unique identifier and/or other data of the electronic device can be encrypted and stored in stored in the memory (e.g. memory 430) of the power-harvesting circuit 104a/404a during the device 100 or power-harvesting circuit 104a, 404a manufacture (e.g., NFC chip 408 manufacture). This encrypted data can be transmitted to and read by NFC activation device 500, decrypted, and compared to the unique identifier to verify the authenticity of the device. As described above, additional data or information stored in stored in the memory (e.g. memory 430) of the power-harvesting circuit 104a/404a can be used to provide other information such as the type of device, the manufacturing date, calibration data, etc. According to some embodiments, this additional information can also be used to validate and authenticate the device.

Non-limiting examples of an NFC activation device 500 applicable to any of the embodiments described above include one or more of a smartphone, a tablet, a laptop, a slate, an e-reader or other electronic reader or hand-held, portable, or wearable computing device, including an Xbox®, a Wii®, or other game system(s).

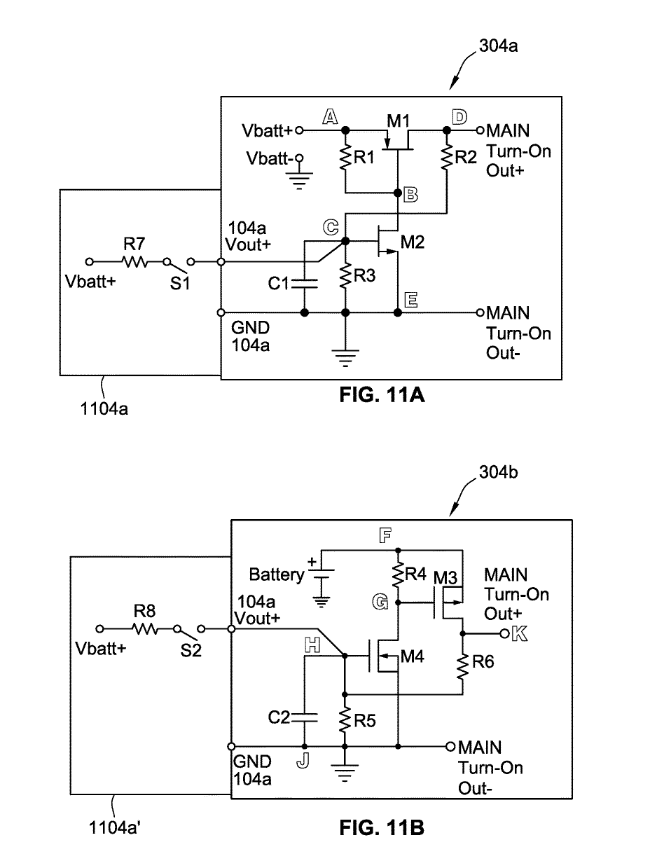

FIGS. 11A and 11B depict reed switch power-harvesting circuits 1104a and 1104a′ and modifications to switch circuits 304a and 304b of FIG. 3A and 3B to work with power-harvesting circuits 1104a and 1104a′. Power-harvesting circuit 1104a comprises a reed switch 51 coupled between a power source Vbatt+ and node C of the switch circuit 304a discussed above in connection with FIG. 3A. Power-harvesting circuit 1104a may also comprise a resistor R7 coupled in between the reed switch S1 and the power source Vbatt+. Power-harvesting circuit 1104a′ comprises a reed switch S2 coupled between a power source Vbatt+ and node H of the switch circuit 304b discussed above in connection with FIG. 3B. Power-harvesting circuit 1104a′ may also comprise a resistor R8 coupled in between the reed switch S2 and the power source Vbatt+. According to some embodiment, a device 100 triggered by a magnetic field could be activated when a software event (such as a user touching an on-screen button on activation device 500) activates an electromagnet to generate this field.

For example, when used in connection with the switch circuits 304a, 304b illustrated in FIGS. 3A and 3B, the switch circuits 304a, 304b serve as a latch. Once a signal is high at the gate of M2 (node C) or gate of M4 (Node H), the switch circuit 304a, 304b activates, closes the connection between the battery 106 and the remainder of the measurement or main circuit 104c and also latches in an ON state. Accordingly, when the signal is removed at node C or H (such as when the magnet is no longer in proximity to device 100), the connection is still maintained. According to some embodiments, the maintenance of the switch 304a, 304b in the latched or ON state is accomplished by using the battery 106 to keep the gate at Node C or Node H high. According to some embodiments, there is latch on the device 500 that checks a status bit in a memory of device 100 such as memory 430, 114, or 104d.

For example, according to some embodiments, when the device 100 is brought into proximity to the activation device 500, an NFC chip 408 inside the device 100 communicates with the activation device 500. At that point, the NFC chip 408 may just transmit some data such as a unique identifier. If an application running on the activation device 500 decides to read the data, it may read additional data transmitted from the NFC IC 420. If the application running on the activation device 500 such as a handset then commands the NFC IC 420 to supply power to the main circuitry 104c of the device 100 such as by sending a turn-on or activation signal, switch 104b will then couple power from the battery 106 to the rest of the circuitry 104c of the device 100.

Generalizing this idea to non-NFC activation, activation device 500 could be any kind of electronic or computing device connected to an activating mechanism. For example, it could be a computer connected to an electromagnet that activates a reed switch. The device 100 receives an appropriate signal (e.g., turn-on or activation signal) from any of a large number of potential sources (e.g., a user touching an on-screen button on an activation device 500, clicking a button with a mouse an activation device 500, pressing a physical button on an activation device 500, a different computer sending a signal over the internet, etc). On receipt of an appropriate signal (e.g., signal generated in response to a user touching the touch-screen of device 500 or clicking a mouse button of activation device), the activation device 500 activates device 100 by sending a turn-on or activation signal. For example, a computer serving as an activation device would turn on an electromagnet to activate the reed switch in device 100.

In operation, when a magnet is in close proximity to electronic device 100, the magnetic field generated by the magnet causes the reed switch S1 or S2 to close, thereby placing a momentary voltage at nodes C or H. The switch circuits 304a and 304b then operate as described above to couple the power source 106 to the main or other circuitry 104c as described above. In the same manner, the device 100 will remain ON even after the magnet is no longer in close proximity to the device 100 and reed switch S1 or S2 opens.

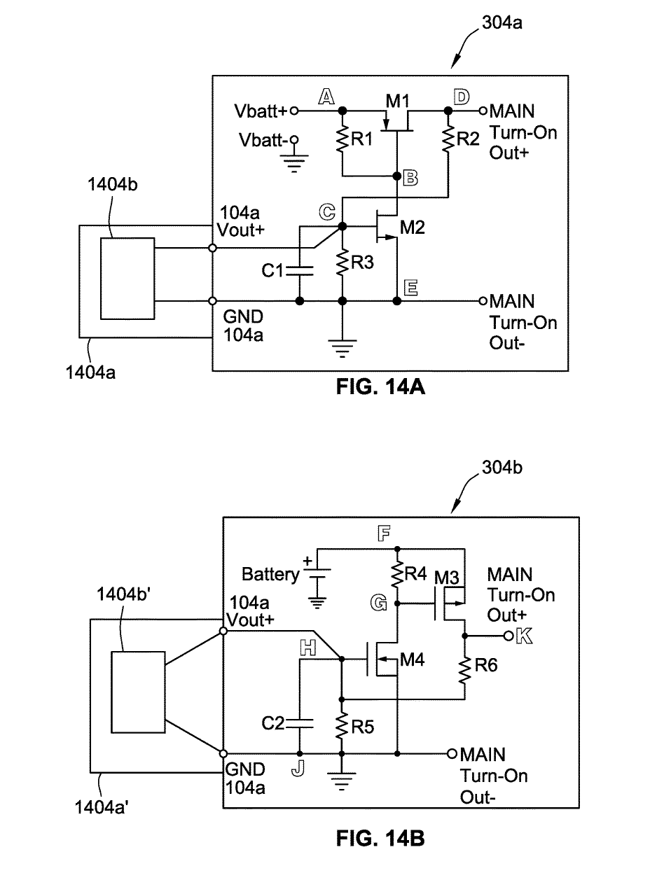

FIGS. 14A and 14B depict optoelectronic circuits 1404a and 1404a′ and modifications to switch circuits 304a and 304b of FIG. 3A and 3B to work with power-harvesting circuits 1404a and 1404a′. Power-harvesting circuit 1404a comprises an optoelectronic device 1404b coupled between a node C of the switch circuit 304a and node E of the switch circuit 304a discussed above in connection with FIG. 3A. Power-harvesting circuit 1404a′ comprises an optoelectronic device 1404b′ coupled between node H of the switch circuit 304b and node J of the switch circuit 304b discussed above in connection with FIG. 3B. According to some embodiment, a device 100 could be activated when light impinging on optoelectronic device 1404b or device 1404b′ generates a voltage at nodes C or H due to the photoelectric effect. The switch circuits 304a and 304b then operate as described above to couple the power source 106 to the main or other circuitry 104c as described above. In the same manner, the device 100 will remain ON even after device 1404b or 1404b′ is no longer exposed to light.

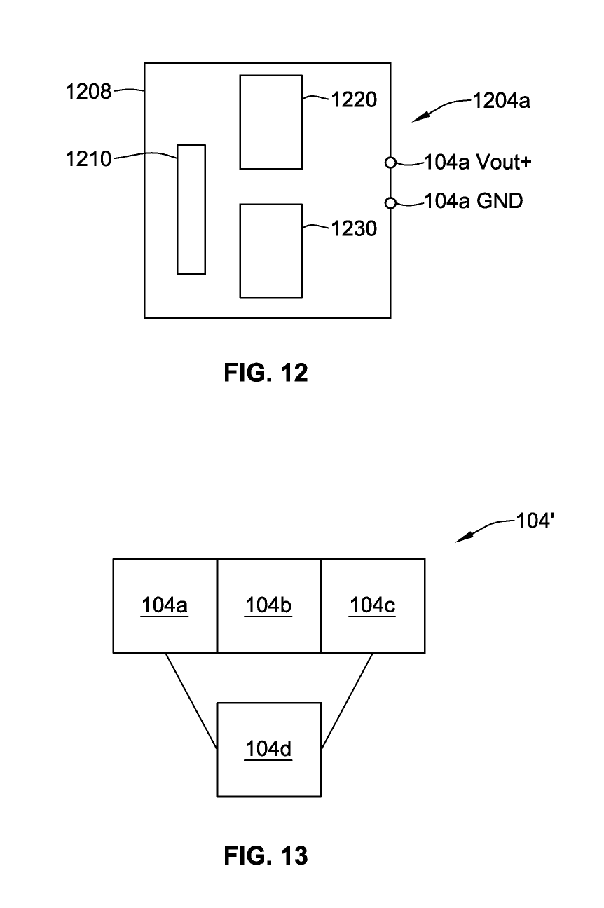

Turning to FIG. 12, according to some embodiments, the power-harvesting circuit 104a is a passive photoelectric circuit 1204a such as a solar cell chip 1208 comprising circuitry such as an solar cell 1210 to generate a turn-on signal in response to light shining on the solar cell 1210. According to some embodiments, the solar cell circuit contains a solar cell 1210 and a transceiver IC 1220. Additionally, according to some embodiments, the solar cell circuitry or chip has its own non-volatile memory 1230. According to some embodiments, the memory 1230 comprises one or more registers and/or other non-volatile memory. According to other embodiments, power-harvesting circuit 104a comprises a solar cell which harvests power or energy from light shining upon the solar cell. Thereafter, the power-harvesting circuit 104a induces a momentary voltage at 104a Vout+ as describes above in connection with, for example, FIGS. 3A and 3B triggering the switch circuit 304a or 304b to couple the power source 106 to the main or other the circuitry 104c as described above.

The unique ID and/or other data including data later generated by the main circuitry 104c may be stored in the memory 1230 and the device 10 may operate as described above such as with reference to the NFC power-harvesting circuit 404a and the ability to exchange data between power-harvesting circuit 1204a and an activation device 500 prior to turning on the device 100 and conditionally turning on the device 100 if the data exchange satisfies predetermined or desired criteria as described above. Likewise, data received in memory 1230 from the main or other circuitry 104c (e.g., test or measurement results) may be communicated from the power-harvesting circuit 1204a even after the power source 106 has been depleted and the device 100 is in an OFF state.

According to some embodiments, the descriptions above in connection with FIGS. 11 and 12 are applicable for both an electromagnetic switch and a thermal switch. A thermal switch operates identically to the above describe reed switch embodiments, but is activated by heat rather than magnetism. For example, old-style mercury thermostats are one example of such a thermal switch. According to some embodiments, optical methods may rely on the photoelectric effect to generate a momentary voltage, and could include solar cells, photodiodes, LEDs, or any other passive photoelectric device.

According to some embodiments, such as those employing electromagnetic activation and a power-harvesting circuit 104a lacking a memory that may be powered via power-harvesting, a memory such as described above (e.g., memory 114, 430, 1230) may be powered by the main power supply 106. In either case, the memory (e.g., memory 114, 430, 1230) can optionally be connected to the rest of the circuit 104c (e.g. so that data generated or collected by the main or other circuit 104c can be stored in such memory for later retrieval, either through an NFC chip 408 or some other method).

FIG. 13 is a block diagram of circuit 104′ on the device 100 according to some embodiments. The circuit 104′ is similar to circuit 104 described above and comprises at least three sections of circuitry. Section 104a is an external power-harvesting circuit. Section 104b comprises switch circuitry. Section 104c comprises other circuitry on the device 100, such as, for example, a memory, a microprocessor, and/or test sensor(s), etc. which may be considered the main operational circuitry of the device 100. Additionally, memory 104d is communicatively coupled to the power-harvesting circuit 104a and/or the main or other circuitry 104c. As was described in more detail in conjunction with FIGS. 3A and 3B, the switch circuitry 104b controls the turning on of the device 100 by allowing or preventing the power source 106 from powering the other or main circuitry 104c. According to some embodiments, some or all of the circuitry 104a, 104b, and/or 104c is solid-state circuitry. Circuit 104a comprises circuitry for sensing an activation signal as described above. For example, as described above such sensing could be performed by an NFC circuit containing an antenna and NFC transceiver IC. According to some embodiments, circuit 104a alternatively or additionally comprises a light sensor, a magnetic switch, or any of the other types of proposed sensors. According to some embodiments, the memory 104d may be part of the power-harvesting circuitry 104a or the main circuitry 104c such as, for example, memory 104d may be memory 430 of NFC chip 408 or memory 1230 that can be accessed by the main circuit 104c and/or receive data from the main circuitry 104c. According to some embodiments, the memory 104d can also be accessed by an activation device such as activation device 500 when the switch circuit 104b is off and the main circuitry 104c is not ON. While particular implementations and applications of the present disclosure have been illustrated and described, it is to be understood that this disclosure is not limited to the precise construction and compositions disclosed herein and that various modifications, changes, and variations can be apparent from the foregoing descriptions without departing from the scope of the invention as defined in the appended claims.

1. A point-of-care medical electronic apparatus comprising:
a housing;
an electrical power source located within the housing and configured to supply electrical current to power the point-of-care medical electronic apparatus; and
a solid-state circuit located within the housing and coupled to the electrical power source so as to be able to selectively receive electrical current from the electrical power source, the solid-state circuit having:
an inactive state in which the electrical current is prevented from flowing through the solid-state circuit, the inactive state corresponding to an OFF mode of the point-of-care medical electronic apparatus, and
an active state in which the electrical current is allowed to flow through the solid-state circuit, the active state corresponding to an ON mode of the point-of-care medical electronic apparatus, the active state being triggered by momentary externally generated electromagnetic radiation being in proximity to the point-of-care medical electronic apparatus and remaining active after the momentary externally electromagnetic generated radiation is no longer in proximity to the point-of-care medical electronic apparatus.

2. The apparatus of claim 1, wherein the momentary externally generated electromagnetic radiation causes a momentary voltage to be generated in the point-of-care medical electronic apparatus, the active state being triggered by the momentary voltage.

3. An apparatus for medical care, the apparatus comprising:
an electrical power source configured to supply electrical current to power the point-of-care medical electronic apparatus;
a solid-state circuit; and
a switch circuit;
an inactive state in which the switch circuit prevents electrical current from flowing from the electrical power source through the solid-state circuit, the inactive state corresponding to an OFF mode of the apparatus, and
an active state in which the switch circuit allows electrical current to flow from the electrical power source through the solid-state circuit, the active state corresponding to an ON mode of the apparatus, the active state being triggered by momentary externally generated electromagnetic radiation being in proximity to the apparatus.

4. The apparatus of claim 3, wherein the apparatus remains in the active state even after the momentary externally generated electromagnetic radiation is no longer in proximity to the apparatus.

5. The apparatus of claim 3, wherein the momentary externally generated electromagnetic radiation causes a momentary voltage to be generated at a node of the switch circuit in the apparatus, the active state being triggered by the presence of the momentary voltage at the node of the switch circuit.

6. The apparatus of claim 1, wherein the momentary externally generated electromagnetic radiation is induced in the apparatus by a Near Field Communications (NFC) device.

7. The apparatus of claim 6, wherein the Near Field Communications (NFC) device is a mobile handset.

8. The apparatus of claim 7, wherein the mobile handset is a handheld device selected from a group consisting of a mobile telephone, a smartphone, a personal digital assistant (PDA), and a tablet.

9. The apparatus of claim 6, wherein the apparatus further comprises an NFC circuit and a switch circuit, and wherein the NFC circuit generates a signal in response to being in proximity to an NFC signal of an NFC activation device and the signal induces the momentary voltage in the switch circuit, and wherein in response to the presence of the momentary voltage in the switch circuit, the switch circuit allows electrical current to flow from the electrical power source through the solid-state circuit.

10. The apparatus of claim 1, wherein the electrical power source is a battery.

11. The apparatus of claim 1, wherein the apparatus is a point-of-care device having a unique identifier (ID), the solid-state circuit outputting a data signal indicative of the ID.

12. The apparatus of claim 1, wherein, in the active state, the solid-state circuit produces one or more output signals indicative of data selected from a group consisting of calibration data, measurement data, and/or identifying data.

13. The apparatus of claim 12, wherein, in the active state, the solid-state circuit produces one or more output signals indicative of measurement data, and wherein the measurement data includes biological diagnostics for one or more of a human immunodeficiency virus (HIV) condition, a malaria condition, a nutrition condition, a neurological disorder condition, a cardiac infraction condition, and/or a hydration condition.

14. The apparatus of claim 1, wherein the momentary voltage is received when the solid-state circuit is placed in close proximity with a mobile handset, the close proximity being at a distance of approximately 4 centimeters or less.

15. A method for activating a discrete point-of-care medical electronic device residing in an initial inactive state, the method comprising:
in response to receiving a momentary voltage from an external Near Field Communications (NFC) activation device, activating an electrical power source of the discrete point-of-care medical electronic device to place the discrete point-of-care medical electronic device in an active state, the electrical power source remaining active independent of the removal of the momentary voltage; and
in response to activating the electrical power source, automatically outputting a confirmation signal used to confirm the discrete point-of-care medical electronic device has been placed in the active state.

16. The method of claim 15, further comprising the discrete point-of-care medical electronic device transmitting a unique identifier (ID) of the electronic device.

17. The method of claim 15, further comprising outputting, via the discrete point-of-care medical electronic device, one or more output signals indicative of data selected from a group consisting of calibration data, measurement data, and identifying data.

18. The method of claim 17, further comprising the discrete point-of-care medical electronic device measuring biological diagnostics for one or more of a human immunodeficiency virus (HIV) condition, a malaria condition, a nutrition condition, a neurological disorder condition, a cardiac infraction condition, and a hydration condition.

19. A medical care system comprising:
a point-of-care medical device having a battery and a circuit enclosed within a housing, the point-of-care medical device being initially in an inactive OFF state in which power from the battery is prevented from flowing through the circuit; and
a Near Field Communications (NFC) activation device outputting a communication signal in close proximity with the point-of-care medical device, the communication signal initiating an active ON state of the point-of-care medical device in which power from the battery is allowed to flow through the circuit, wherein the active ON state of the point-of-care medical device is maintained regardless of whether the NFC activation device thereafter remains in close proximity with the point-of-care medical device.

20. The medical care system of claim 19, wherein the point-of-care medical device has a unique identifier (ID) that is automatically transmitted to the activation device before the active ON state of the point-of-care medical device is initiated.

21. The medical care system of claim 19, wherein the NFC activation device is a handheld device selected from a group consisting of a mobile telephone, a smartphone, a personal digital assistant (PDA), and a tablet.

22. The medical care system of claim 19, wherein the point-of-care medical device and the NFC activation device are configured to communicate data selected from a group consisting of calibration data, measurement data, and identifying data.

23. The medical care system of claim 20, wherein the point-of-care medical device and the NFC activation device are configured to communicate measurement data, and wherein the measurement data includes biological diagnostics for one or more of a human immunodeficiency virus (HIV) condition, a malaria condition, a nutrition condition, a neurological disorder condition, a cardiac infraction condition, and a hydration condition.

24. The medical care system of claim 23, wherein the communicated measurement data is stored on one or more of the NFC activation device and an external storage facility.

25. The apparatus of claim 1, wherein the solid-state circuit is configured to latch in the ON mode.

26. The apparatus of claim 25, wherein the solid-state circuit includes at least one transistor, and the at least one transistor latches on with the solid-state circuit in the ON mode.

27. The apparatus of claim 26, wherein the at least one transistor is latched on based, at least in part, on the electrical power from the electrical power source.

28. The apparatus of claim 1, wherein the point-of-care medical apparatus is a discrete device.

29. The apparatus of claim 1, wherein the ON mode of the point-of-care medical electronic apparatus corresponds to performing one or more point-of-care diagnostic tests.

30. The apparatus of claim 1, wherein the solid-state circuit includes a first transistor configured to complete an electrical connection with the electrical power source to allow the electrical current to flow through the point-of-care medical electronic apparatus.

31. The apparatus of claim 30, wherein a source of the first transistor is coupled to a first node, and a first end of a first resistor is coupled to the first node.

32. The apparatus of claim 31, wherein the electrical power source is coupled directly to the first node.

33. The apparatus of claim 32, wherein a gate of the first transistor and a second end of the first resistor is coupled to a second node.

34. The apparatus of claim 33, wherein the solid-state circuit further includes a second transistor, a second resistor, and a third resistor, the second resistor is coupled between a third node and a drain of the first transistor at a fourth node, a gate of the second transistor is coupled to the third node, the drain of the second transistor is coupled to the gate of the first transistor at the second node, a source of the second transistor is coupled to a fifth node, and the third resistor is coupled between the third node and the fifth node.

35. The method of claim 15, prior to activating the electrical power source of the discrete point-of-care medical electronic device, further comprising:
providing identification information of the discrete point-of-care medical electronic device to the NFC activation device; and
determining whether to apply the momentary voltage based on the identification information.

36. The method of claim 35, wherein the identification information identifies a type of the discrete point-of-care medical electronic device, a power status of the discrete point-of-care medical electronic device, or a combination thereof.

37. The method of claim 35, further comprising:
linking a patient record stored within memory of the NFC activation device with the identification information of the discrete point-of-care medical electronic device.
